(19) United States
(12) Patent Application Publication
(10) Pub. No.: US 2012/0062764 A1
(43) Pub. Date: Mar. 15, 2012

(54) DATA MANAGEMENT DEVICE AND RECORDING MEDIUM

(75) Inventors: Akira Shinozawa, Kawasaki (JP); Shusaku Nagasaki, Kawasaki (JP); Yoshiyuki Imai, Kawasaki (JP)

(73) Assignee: FUJITSU LIMITED, Kawasaki-shi (JP)

(21) Appl. No.: 13/226,114

(22) Filed: Sep. 6, 2011

(30) Foreign Application Priority Data
Sep. 9, 2010 (JP) 2010-202334

(51) Int. Cl. H04N 5/225

(52) U.S. Cl. 348/231.2; 348/E05.024

(57) ABSTRACT

A data management device includes an input controller which accepts an input of a data acquisition instruction in a state in which a folder image relating to a folder in which data is to be stored is displayed on a display unit, a data acquisition controller which acquires data from a data acquisition unit in accordance with the data acquisition instruction accepted by the input controller and a data management unit which stores the data acquired by the data acquisition unit in a data storage unit with associating the acquired data with a folder specified by the folder image displayed on the display unit when the data acquisition instruction is accepted.

### CROSS-REFERENCE TO RELATED APPLICATION

This application is based upon and claims the benefit of priority of the prior Japanese Patent Application No. 2010-202334, filed on Sep. 9, 2010, the entire contents of which are incorporated herein by reference.

### FIELD

The embodiment discussed herein is related to a data management device and a recording medium.

### BACKGROUND

In the past, in electronic devices such as cameras, mobile phone devices, and the like, which include functions for shooting pieces of data such as images, video pictures, and the like, when pieces of data acquired by shooting are stored in storage units, the pieces of data have been usually stored in preliminarily set folders.

In addition, an electronic device including a function such as infrared communication or Bluetooth (registered trademark) communication exchanges data with another electronic device, using a data communication function, and acquires data such as image, a piece of music, and the like from the other electronic device. Also in this case, usually, the electronic device stores the acquired data in a preliminarily set folder.

It is known that, in such an electronic device, a user newly creates an arbitrary folder and sorts data into the new folder. However, in a technique of the related art, after data acquired by image shooting or data communication is stored in a preliminarily set folder once, the stored data is manually moved to a new folder. Therefore, an operation for data management is complicated.

As one of techniques solving such difficulty, in Japanese Laid-open Patent Publication No. 2001-169222, a technique is disclosed in which, in an electronic camera such as a digital camera or the like, a user is prompted to preliminarily designate a storage folder on the basis of a storage folder selection menu, and captured image data is stored in the designated storage folder.

In this technique, after setting a storage destination folder for data, the user returns to an initial screen such as, for example, the standby screen of a mobile phone device or the like, shifts to a screen used for activating an image shooting function or a data communication function, and then activates the image shooting function or the data communication function.

### SUMMARY

According to an aspect of an embodiment, a data management device includes an input controller which accepts an input of a data acquisition instruction in a state in which a folder image relating to a folder in which data is to be stored is displayed on a display unit, a data acquisition controller which acquires data from a data acquisition unit in accordance with the data acquisition instruction accepted by the input controller and a data management unit which stores the data acquired by the data acquisition unit in a data storage unit with associating the acquired data with a folder specified by the folder image displayed on the display unit when the data acquisition instruction is accepted.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a hardware configuration of a mobile phone device according to a first embodiment;

FIG. 2 is a diagram illustrating a functional block of the mobile phone device according to the first embodiment;

FIG. 3 is a diagram illustrating an example of a folder list image according to the first embodiment;

FIG. 4 is a diagram illustrating an example of a data list image according to the first embodiment;

FIG. 5 is a flow diagram illustrating data management processing of the mobile phone device according to the first embodiment;

FIG. 6 is a diagram illustrating an example of a data storage situation of a folder B before acquired data is stored;

FIG. 7 is a diagram illustrating an example of a data storage situation of the folder B after acquired data is stored;

FIG. 8 is a diagram illustrating an example of a data list image after acquired data is stored;

FIG. 9 is a diagram illustrating a hardware configuration of a mobile phone device according to a second embodiment;

FIG. 10 is a diagram illustrating a functional block of the mobile phone device according to the second embodiment;

FIG. 11 is a diagram illustrating an example of a folder list image according to the second embodiment;

FIG. 12 is a diagram illustrating an example of a data list image according to the second embodiment; and

FIG. 13 is a flow diagram illustrating data management processing of the mobile phone device according to the second embodiment.

### DESCRIPTION OF EMBODIMENTS

Hereinafter, embodiments of a data management device and a recording medium disclosed in the application will be described in detail on the basis of figures. In addition, it should be understood that a disclosed technique is not limited by the embodiments. For example, while, in the following embodiments, as one example of the data management device, a mobile phone device will be cited and described, the data management device may be an electronic device such as a camera or the like capable of acquiring image data on the basis of an image capturing function or an electronic device capable of acquiring data on the basis of a data communication function.

### First Embodiment

In a first embodiment, an example will be described in which a mobile phone device including an infrared communication function acquires data from another electronic device using infrared communication, and stores the acquired data in an arbitrary folder. In addition, the term “folder” in this case means a folder virtually grouping data stored in a data storage unit within the mobile phone device, and the term “storing in a folder” means storing data stored in the data storage unit with associating the data with a specific folder. In addition, the data acquired by the mobile phone device is not limited to image data, and the acquired data may also be data of any type such as moving image data, music data, or the like, which can be categorized, as a data file, into a folder and stored within the mobile phone device.

In addition, the communication function is not limited to the infrared communication, and the communication function may be realized using wireless communication such as Bluetooth (registered trademark) communication or the like or realized using wire communication. In addition, even if data is not acquired from another electronic device but is acquired from an external recording medium such as a memory card or the like, it is possible to realize the communication function. In addition, when data is stored in a folder, the data is not recorded in the folder in actual processing but the data is recorded with association information, associated with the folder, being generated as management data when the data is stored in the data storage unit included in the electronic device. However, in the present specification, for convenience of description, in some cases, to generate the association information associated with the folder in such a way will be described using the expression “stored in the folder”.

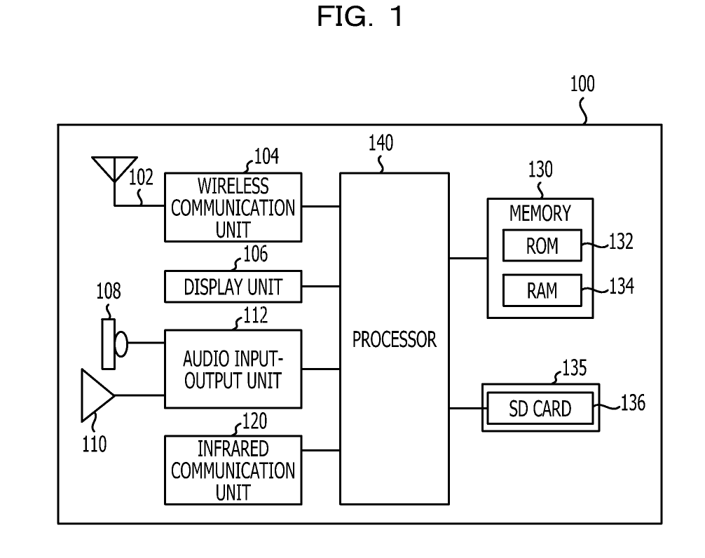

FIG. 1 is a diagram illustrating the hardware configuration of a mobile phone device according to a first embodiment. As illustrated in FIG. 1, a mobile phone device 100 of the present embodiment includes a wireless communication unit 104, a display unit 106, an audio input-output unit 112, an infrared communication unit 120, a memory 130, a Secure Digital (SD) card insertion slot 135, and a processor 140. An SD card 136 is inserted into the SD card insertion slot 135.

The wireless communication unit 104 performs wireless communication for various kinds of data such as sound, characters, and the like through an antenna 102 provided in the mobile phone device 100. The display unit 106 is an output interface such as a liquid crystal panel that displays various kinds of information such as characters, images, and the like. In addition, the audio input-output unit 112 is an input-output interface that inputs sound through a microphone 108 provided in the mobile phone device 100 and outputs sound through a speaker 110.

The infrared communication unit 120 is a data acquisition unit that performs data transmission and reception by performing infrared communication with another electronic device, and acquires data from the other electronic device. The memory 130 includes a read only memory (ROM) 132 storing therein data used for executing various kinds of functions of the mobile phone device 100 and a random access memory (RAM) 134 storing therein various kinds of programs used for executing various kinds of functions.

The processor 140 is a central processing unit (CPU) that executes the various kinds of programs stored in the RAM 134. By executing the various kinds of programs stored in the RAM 134, the processor 140 controls the wireless communication unit 104, the display unit 106, the audio input-output unit 112, and the infrared communication unit 120, which are described above. In addition, a program executed in the processor 140 is not only stored in the RAM 134 but also is recorded in a recording medium such as a compact disc (CD)-ROM, a memory medium, or the like which can be distributed, and the program can be read out and executed from the recording medium. Furthermore, the program may also be stored in a server connected through a network, and caused to operate on the server, and it may also be possible to provide a service to a terminal device, which is a request source, in response to a request from the terminal device connected through the network.

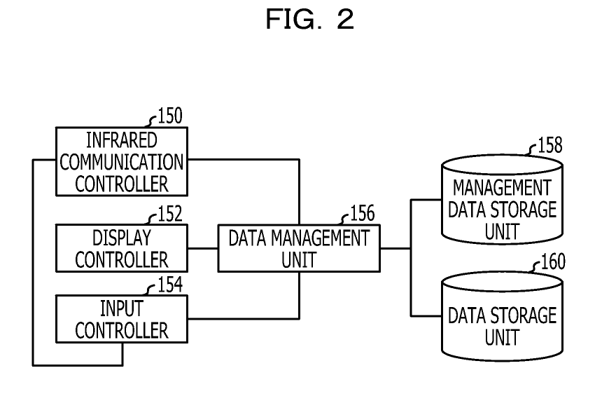

FIG. 2 is a diagram illustrating the functional block of the mobile phone device 100 according to the first embodiment. As functional blocks realized by the processor 140 by reading out and executing the various kinds of programs from the RAM 134, the mobile phone device 100 includes an infrared communication controller 150, a display controller 152, an input controller 154, and a data management unit 156. In addition, the mobile phone device 100 includes a management data storage unit 158 and a data storage unit 160. For example, the management data storage unit 158 and the data storage unit 160 are storage units for data, provided within the RAM 134.

By controlling the infrared communication unit 120, the infrared communication controller 150 executes the activation control and the halt control of an infrared communication function and the control of data transmission and reception to and from another electronic device, performed using the infrared communication. The display controller 152 executes control relating to a display image displayed on the display unit 106. For example, the display controller 152 causes the display unit 106 to display a folder image relating to a folder in which data is stored. The detail of the folder image will be described later.

The input controller 154 accepts an input instruction issued from the key of the mobile phone device 100 and an input instruction issued on the display of the display unit 106. For example, the input controller 154 accepts the input of an instruction used for data acquisition based on the infrared communication unit 120. The data management unit 156 stores, in the data storage unit 160, data acquired by the infrared communication unit 120 with associating the data with a folder, specified by the folder image displayed on the display unit 106 when the data acquisition instruction is accepted. The detail of the data management unit 156 will be described later.

The data storage unit 160 is a storage area in which data acquired from another electronic device or the like is stored. In addition, the management data storage unit 158 is a storage area in which the attribute information of the data stored in the data storage unit 160 is stored. For example, the attribute information of the data is attribute information such as the information of a folder in which the data is stored, or the like.

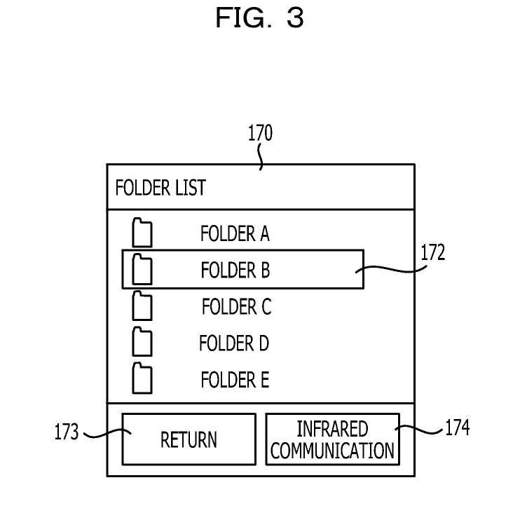

Next, as examples of the folder image displayed on the display unit 106, a folder list image and a data list image will be described. FIG. 3 is a diagram illustrating an example of the folder list image according to the first embodiment. As illustrated in FIG. 3, a folder list image 170 is an image in a state in which a plurality of folder A to folder E to be candidates for storing data are displayed on the display unit 106 and one of the plural folder A to folder E is selected. For example, with respect to the selection operation for a folder, a selection cursor 172 is operated up and down using an up-and-down operation key of an operation unit in the mobile phone device 100, a selected folder is highlighted, and hence an arbitrary folder can be selected. The folder list image 170 in FIG. 3 indicates a state in which the folder B is selected from among the folder A to folder E. In the present embodiment, an example will be descried in which data acquired from another electronic device using infrared communication is stored in the folder B. In addition, as illustrated in FIG. 3, in a state in which the folder list image 170 is displayed on the display unit 106, a return button 173 and an infrared communication button 174 can be individually subjected to press-down operations.

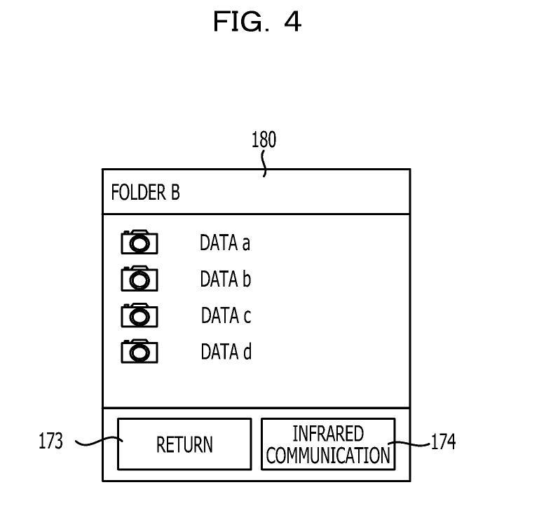

FIG. 4 is a diagram illustrating an example of the data list image according to the first embodiment. FIG. 4 is an image displayed when an execution key of the operation unit in the mobile phone device 100 is pressed down in a state in which the folder B is selected by the selection cursor 172 in the folder list image 170 in FIG. 3, for example. As illustrated in FIG. 4, a data list image 180 is an image in a state in which a plurality of data which stored in the folder B is displayed. In addition, as illustrated in FIG. 4, in a state in which the data list image 180 is displayed on the display unit 106, the return button 173 and the infrared communication button 174 can be individually subjected to press-down operations.

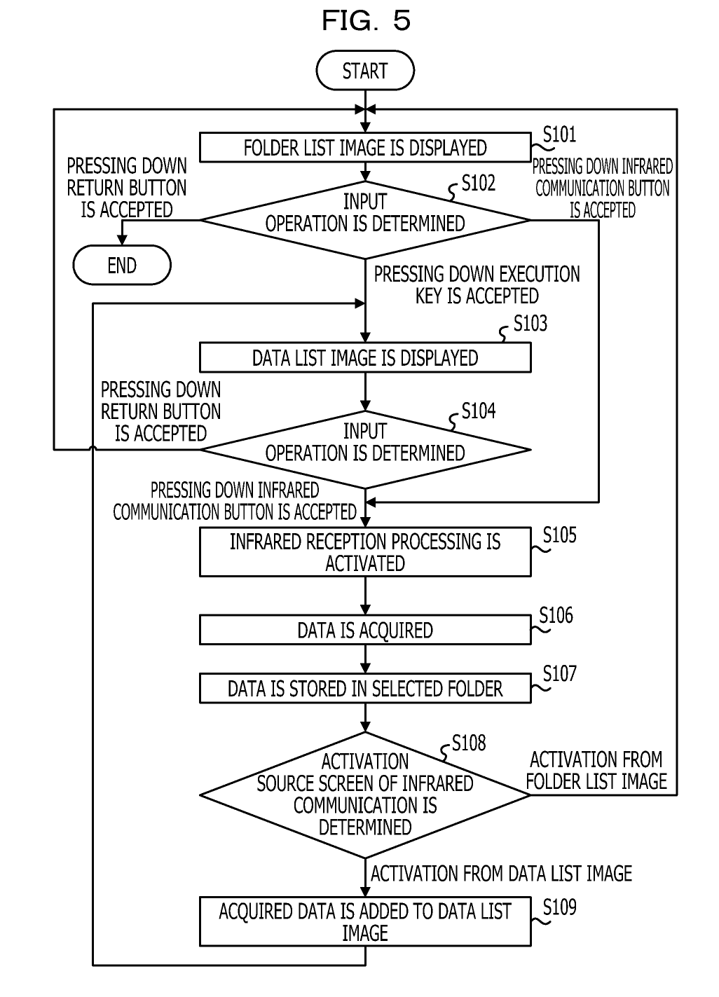

Next, the data management processing of the mobile phone device 100 of the first embodiment will be described. FIG. 5 is a flow diagram illustrating the data management processing of the mobile phone device according to the first embodiment. As illustrated in FIG. 5, in the data management processing, first, the display controller 152 displays the folder list image 170 on the display unit 106 (Step S101). Subsequently, the data management unit 156 determines which input operation has been performed in a state in which the folder list image 170 is displayed (Step S102). Specifically, the data management unit 156 determines whether the return button 173 has been operated, the execution key of the operation unit in the mobile phone device 100 has been operated, or the infrared communication button 174 has been operated. The data management unit 156 terminates the processing when the return button 173 has been operated. In addition, when the data management unit 156 determines that the execution key of the operation unit in the mobile phone device 100 has been operated, the display controller 152 displays, on the display unit 106, the data list image 180 of a folder selected by the selection cursor 172 (Step S103).

After having displayed the data list image 180, the data management unit 156 determines which input operation has been performed in a state in which the data list image 180 is displayed (Step S104). Specifically, the data management unit 156 determines whether the return button 173 has been operated or the infrared communication button 174 has been operated. The data management unit 156 returns to Step S101 when the return button 173 has been operated. In addition, when, in Step S102 or Step S104, the data management unit 156 determines that the infrared communication button 174 has been operated, the infrared communication controller 150 activates infrared reception processing (Step S105).

Subsequently, the infrared communication controller 150 acquires data from another mobile phone device using infrared communication (Step S106). Subsequently, the data management unit 156 stores the acquired data in a selected folder (Step S107). Specifically, when the infrared communication button 174 has been operated, the data management unit 156 stores the acquired data in the data storage unit 160 with associating the acquired data with the folder selected by the selection cursor 172 in the folder list image 170. Alternatively, when the infrared communication button 174 has been operated, the data management unit 156 stores the acquired data in the data storage unit 160 with associating the acquired data with a folder whose data content has been displayed in the data list image 180. In addition, as the attribute information of the acquired data stored in the data storage unit 160, the data management unit 156 stores, in the management data storage unit 158, information indicating which folder the acquired data is associated with.

In the present embodiment, it is assumed that, as the attribute information of the acquired data, the data management unit 156 associates the acquired data with a preliminarily set acquired-data-use folder, a data exchange-use folder, or the like and associates the acquired data with a folder that has been selected at the time of the activation of the infrared communication. According to this, it is possible to make a user aware that the acquired data apparently seems to be stored in both of a folder preliminarily set by the initial setting of the mobile phone device 100 or the like and a folder selected at the time of the activation of the infrared communication, and hence it is possible to improve the operability of the search of the acquired data. In this regard, however, as the attribute information of the acquired data, the data management unit 156 may also associate the acquired data only with the folder selected at the time of the activation of the infrared communication.

Subsequently, the data management unit 156 determines a screen of an activation source of the infrared communication (Step S108). Specifically, when the infrared communication button 174 has been operated, the data management unit 156 determines whether an image that has been displayed on the display unit 106 is the folder list image 170 or the data list image 180. When determining that the infrared communication has been activated from the folder list image 170, the data management unit 156 returns to Step S101. On the other hand, when determining that the infrared communication has been activated from the data list image 180, the data management unit 156 adds the acquired data to the data list image 180 (Step S109), and returns to Step S103.

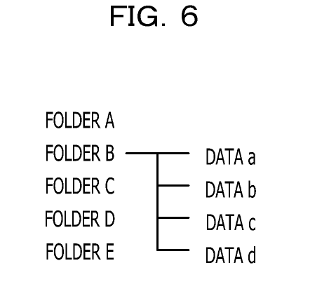

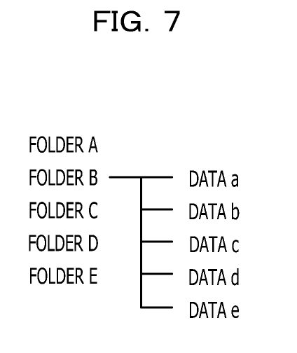

FIG. 6 is a diagram illustrating an example of the data storage situation of the folder B before acquired data is stored, and FIG. 7 is a diagram illustrating an example of the data storage situation of the folder B after acquired data is stored. As illustrated in FIG. 6, a plurality of data has been stored in the folder B before the acquired data is stored, data e is newly added to the folder B after the acquired data has been stored, and the data a to data e are stored.

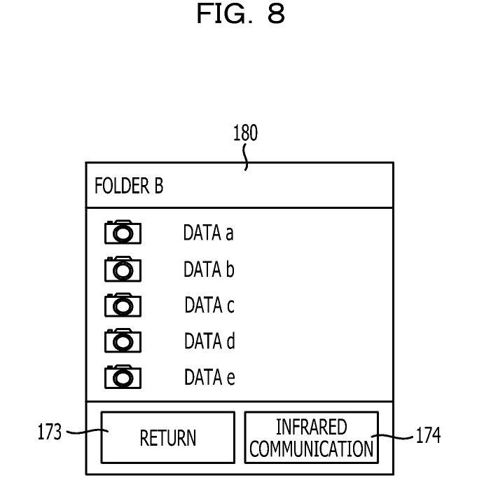

FIG. 8 is a diagram illustrating an example of the data list image after the acquired data has been stored. As illustrated in FIG. 8, when the acquired data has been added to the data list image 180 owing to Step S109, the data a to data e are displayed in the data list image 180.

As described above, according to the mobile phone device 100 of the present embodiment, it is possible to swiftly store the acquired data in an arbitrary folder with an easy operation. Namely, it has been known that, in a mobile phone device of the related art, data acquired from another electronic device using infrared communication is stored in a preliminarily set folder such as an acquired-data-use folder, a data exchange-use folder, or the like, for example. In this case, since, in order to create an arbitrary new folder and store the acquired data in the new folder, the user manually moves the data from the preliminarily set folder to the new folder, the operation becomes complicated. In addition, a technique has been known in which an acquired data is stored in an arbitrary folder created by a user. In this case, returning to a standby screen of a mobile phone device after a folder used for storing the acquired data has been created, a menu operation is performed from the standby screen, and infrared communication is activated. Therefore, the operation is complicated, and it is difficult to swiftly acquire data after a folder used for storing the data is selected. On the other hand, in the mobile phone device 100 of the present embodiment, it is possible to swiftly store the acquired data in a desired folder with an easy and intuitive operation of pressing down the infrared communication button 174, from a state in which a folder is selected in the folder list image 170 or the data list image 180.

### Second Embodiment

Hereinafter, a mobile phone device 200 according to a second embodiment will be described. While, in the first embodiment, an example has been described in which the data acquire from the external electronic device using the infrared communication is stored in an arbitrary folder, an example will be described in which the mobile phone device of the second embodiment includes an image capturing function based on a camera and stores data shot by the camera in an arbitrary folder. In addition, while the second embodiment will be described using the mobile phone device as an example of the data management device, the second embodiment is not limited to the mobile phone device but may also be applied to an electronic device such as a personal digital assistant (PDA), a digital camera, or the like, which includes an image capturing function based on a camera.

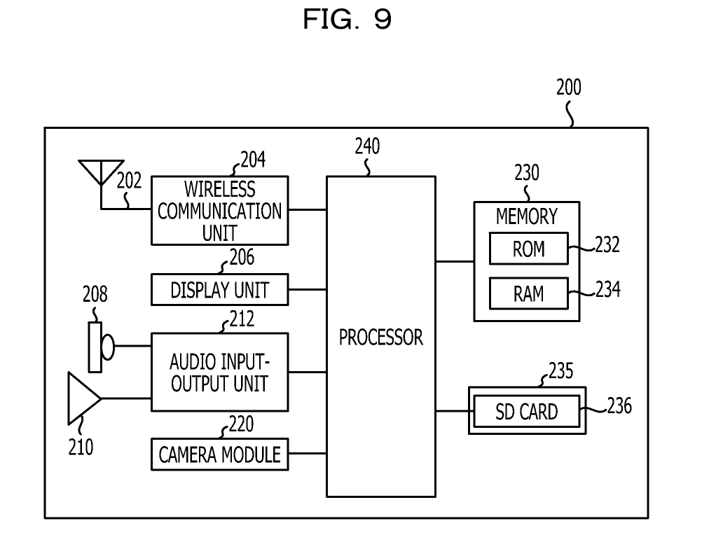

FIG. 9 is a diagram illustrating the hardware configuration of the mobile phone device according to the second embodiment. As illustrated in FIG. 9, the mobile phone device 200 of the present embodiment includes a wireless communication unit 204, a display unit 206, an audio input-output unit 212, a camera module 220, a memory 230, a Secure Digital (SD) card insertion slot 235, and a processor 240. An SD card 236 is inserted into the SD card insertion slot 235.

Since the wireless communication unit 204, the display unit 206, and the audio input-output unit 212 are the same as the wireless communication unit 104, the display unit 106, and the audio input-output unit 112 in the mobile phone device 100 of the first embodiment, the descriptions thereof will be omitted. In addition, since the memory 230 and the processor 240 are the same as the memory 130 and the processor 140 in the mobile phone device 100 of the first embodiment, the descriptions thereof will be omitted.

The camera module 220 is an image capturing unit including components such as an lens, an image sensor, a signal processing device, and the like, and acquires image data or the like using the image capturing function.

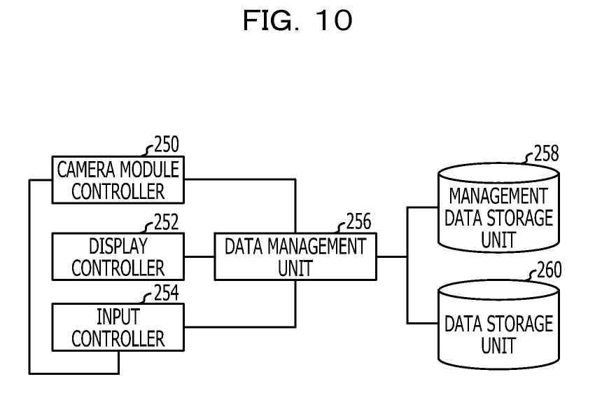

FIG. 10 is a diagram illustrating the functional block of the mobile phone device 200 according to the second embodiment. As functional blocks realized by the processor 240 by reading out and executing various kinds of programs from the RAM 234, the mobile phone device 200 includes a camera module controller 250, a display controller 252, an input controller 254, and a data management unit 256. In addition, the mobile phone device 200 includes a management data storage unit 258 and a data storage unit 260. For example, the management data storage unit 258 and the data storage unit 260 are storage units for data, provided within the RAM 234.

By controlling the camera module 220, the camera module controller 250 executes the control of image-data capturing performed by the image capturing function. Since the display controller 252, the input controller 254, and the data management unit 256 are the same as the display controller 152, the input controller 154, and the data management unit 156 in the mobile phone device 100 of the first embodiment, the descriptions thereof will be omitted. In addition, since the data storage unit 260 and the management data storage unit 258 are the same as the data storage unit 160 and the management data storage unit 158 in the mobile phone device 100 of the first embodiment, the descriptions thereof will be omitted.

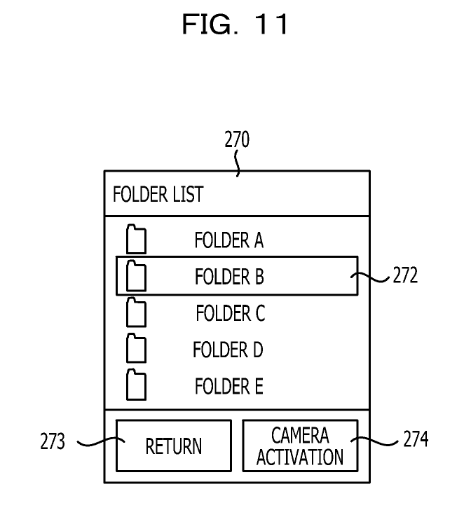

Next, a folder list image and a data list image displayed on the display unit 206 will be described. FIG. 11 is a diagram illustrating an example of the folder list image according to the second embodiment. As illustrated in FIG. 11, a folder list image 270 is an image in a state in which a plurality of folder A to folder E to be candidates for storing data are displayed on the display unit 206 and one of the plural folder A to folder E is selected. For example, with respect to the selection operation for a folder, a selection cursor 272 is operated up and down using an up-and-down operation key of an operation unit in the mobile phone device 200, a selected folder is highlighted, and hence an arbitrary folder can be selected. The folder list image 270 in FIG. 11 indicates a state in which the folder B is selected from among the folder A to folder E. In the present embodiment, an example will be descried in which data acquired from another electronic device using infrared communication is stored in the folder B. In addition, as illustrated in FIG. 11, in a state in which the folder list image 270 is displayed on the display unit 206, a return button 273 and a camera activation button 274 can be individually subjected to press-down operations.

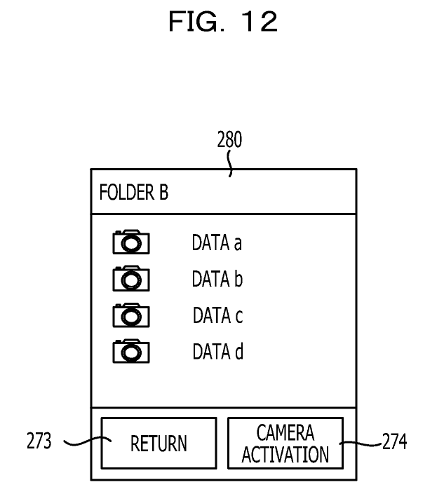

FIG. 12 is a diagram illustrating an example of the data list image according to the second embodiment. FIG. 12 is an image displayed when an execution key of the operation unit in the mobile phone device 200 is pressed down in a state in which the folder B is selected by the selection cursor 272 in the folder list image 270 in FIG. 11, for example. As illustrated in FIG. 12, a data list image 280 is an image in a state in which a plurality of data stored in the folder B is displayed. In addition, as illustrated in FIG. 12, in a state in which the data list image 280 is displayed on the display unit 206, the return button 273 and the camera activation button 274 can be individually subjected to press-down operations.

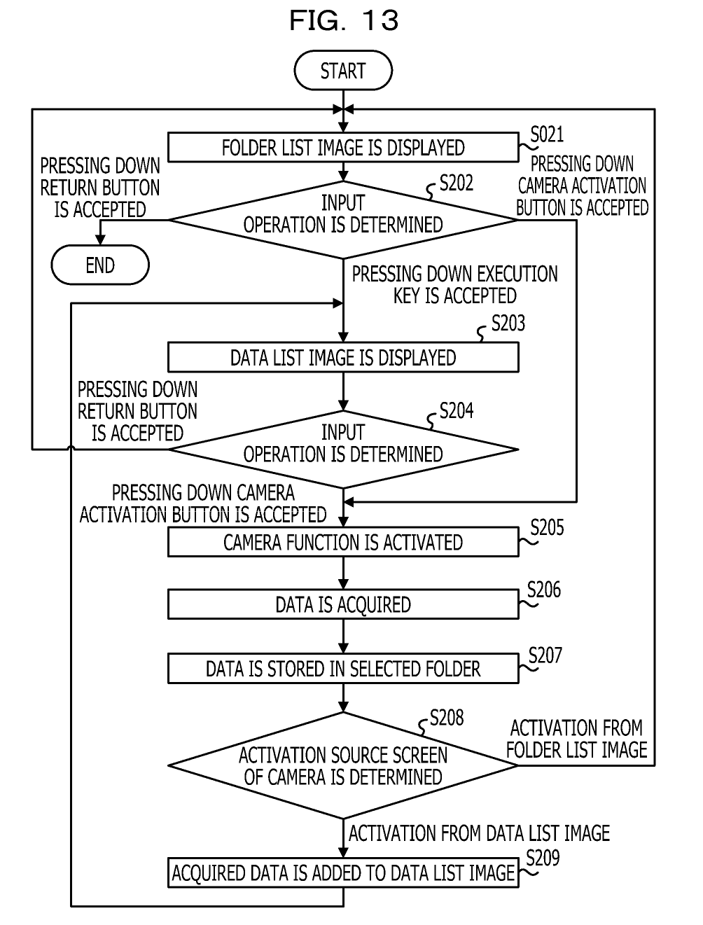

Next, the data management processing of the mobile phone device 200 of the second embodiment will be described. FIG. 13 is a flow diagram illustrating the data management processing of the mobile phone device according to the second embodiment. As illustrated in FIG. 13, in the data management processing, first, the display controller 252 displays the folder list image 270 on the display unit 206 (Step S201). Subsequently, the data management unit 256 determines which input operation has been performed in a state in which the folder list image 270 is displayed (Step S202). Specifically, the data management unit 256 determines whether the return button 273 has been operated, the execution key of the operation unit in the mobile phone device 200 has been operated, or the camera activation button 274 has been operated. The data management unit 256 terminates the processing when the return button 273 has been operated. In addition, when the data management unit 256 determines that the execution key of the operation unit in the mobile phone device 200 has been operated, the display controller 252 displays, on the display unit 206, the data list image 280 of a folder selected by the selection cursor 272 (Step S203).

After having displayed the data list image 280, the data management unit 256 determines which input operation is performed in a state in which the data list image 280 is displayed (Step S204). Specifically, the data management unit 256 determines whether the return button 273 has been operated or the camera activation button 274 has been operated. The data management unit 256 returns to Step S201 when the return button 273 has been operated. In addition, when, in Step S202 or Step S204, the data management unit 256 determines that the camera activation button 174 has been operated, the camera module controller 250 activates a camera function (Step S205).

Subsequently, the camera module controller 250 acquires data on the basis of image capturing based on the camera (Step S206). Subsequently, the data management unit 256 stores the acquired data in a selected folder (Step S207). Specifically, when the camera activation button 274 has been operated, the data management unit 256 stores the acquired data in the data storage unit 260 with associating the acquired data with the folder selected by the selection cursor 272 in the folder list image 270. Alternatively, when the camera activation button 274 has been operated, the data management unit 256 stores the acquired data in the data storage unit 260 with associating the acquired data with a folder whose data content has been displayed in the data list image 280. In addition, as the attribute information of the acquired data stored in the data storage unit 260, the data management unit 256 stores, in the management data storage unit 258, information indicating which folder the acquired data is associated with.

In the present embodiment, it is assumed that, as the attribute information of the acquired data, the data management unit 256 associates the acquired data with a preliminarily set acquired-data-use folder, a preliminarily set data exchange-use folder, or the like and associates the acquired data with a folder that has been selected at the time of the activation of the camera. According to this, it is possible to make a user aware that the acquired data apparently seems to be stored in both of a folder preliminarily set by the initial setting of the mobile phone device 200 or the like and a folder selected at the time of the activation of the camera, and hence it is possible to improve the operability of the search of the acquired data. In this regard, however, as the attribute information of the acquired data, the data management unit 256 may also associate the acquired data only with the folder selected at the time of the activation of the camera.

Subsequently, the data management unit 256 determines a screen of an activation source of the camera function (Step S208). Specifically, when the camera activation button 274 has been operated, the data management unit 256 determines whether an image that has been displayed on the display unit 206 is the folder list image 270 or the data list image 280. When determining that the camera function has been activated from the folder list image 270, the data management unit 256 returns to Step S201. On the other hand, when determining that the camera function has been activated from the data list image 280, the data management unit 256 adds the acquired data to the data list image 280 (Step S209), and returns to Step S203. In addition, the data storage situations of the folder B before and after the acquired data is stored, and the data list image after the acquired data is stored are the same as in FIG. 6 to FIG. 8 described in the first embodiment.

As described above, according to the mobile phone device 200 of the second embodiment, in the same way as in the mobile phone device 100 of the first embodiment, it is possible to swiftly store the acquired data in an arbitrary folder with an easy operation. Namely, according to the mobile phone device 200 of the second embodiment, it is possible to swiftly store the acquired data in a desired folder with an easy and intuitive operation of pressing down the camera activation button 274, from a state in which a folder is selected in the folder list image 270 or the data list image 280.

In addition, while the first and second embodiments have been mainly described with an emphasis on the data management device and the data management method, the first and second embodiments are not limited to the examples, and the same functions as those of the first and second embodiments may be realized by executing a data management program prepared in advance, on a computer. Namely, the data management program causes the computer to execute processing for accepting an instruction for data acquisition performed by a data acquisition unit, in a state where a folder image relating to a folder in which data is to be stored is displayed on a display unit. In addition, the data management program causes the computer to execute processing in which the data acquisition unit is controlled in accordance with the accepted data acquisition instruction and the data is acquired. In addition, the data management program causes the computer to execute processing in which the acquired data is stored in a data storage unit with being associating with a folder, specified by the folder image displayed on the display unit when the data acquisition instruction is accepted. In addition, it is possible to distribute the data management program to the computer through a communication network such as Internet or the like. In addition, the data management program is recorded in a memory or a hard disk, provided in the computer, or in a non-transitory computer-readable recording medium available to another computer, and may also be read out by the computer from a non-transitory recording medium, thereby being executed.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

1. A data management device comprising:
an input controller which accepts an input of a data acquisition instruction in a state in which a folder image relating to a folder in which data is to be stored is displayed on a display unit;
a data acquisition controller which acquires data from a data acquisition unit in accordance with the data acquisition instruction accepted by the input controller; and
a data management unit which stores the data acquired by the data acquisition unit in a data storage unit with associating the acquired data with a folder specified by the folder image displayed on the display unit when the data acquisition instruction is accepted.

2. The data management device according to claim 1, wherein
the folder image is a folder list image in a state in which a plurality of folders to be candidates for storing the data are displayed and one of the plural folders is selected, or a data list image in a state in which the data stored in the folder is displayed.

3. The data management device according to claim 1, wherein
the data acquisition unit is a data communication unit that acquires data from another device using data communication or an image capturing unit that acquires data using an image capturing function.

4. A computer-readable recording medium in which a data management program is recorded,
the data management program causing a data management device to execute processing including:
accepting an input of an instruction for data acquisition performed by a data acquisition unit in a state in which a folder image relating to a folder in which data is to be stored is displayed on a display unit;
acquiring data from the data acquisition unit in accordance with the accepted data acquisition instruction; and
storing the acquired data in a data storage unit with associating the acquired data with a folder specified by the folder image displayed on the display unit when the data acquisition instruction is accepted.
